(19) United States
(12) Patent Application Publication
(10) Pub. No.: US 2010/0272969 A1
(43) Pub. Date: Oct. 28, 2010

(54) FLEXIBLE, IMPACT-RESISTANT LAMINATE AND A METHOD OF MANUFACTURING SAME

(75) Inventor: David Stirling Taylor, Accrington (GB)

Correspondence Address: EGBERT LAW OFFICES, 412 MAIN STREET, 7TH FLOOR, HOUSTON, TX, 77002, US

(73) Assignee: STIRLING MOULDED COMPOSITES LIMITED, Accrington (GB)

(21) Appl. No.: 12/294,872

(22) PCT Filed: Oct. 9, 2007
(86) PCT No.: PCT/GB2007/003845

§ 371 Date: Jul. 7, 2010

(30) Foreign Application Priority Data
Oct. 11, 2006 (GB) 0620110.7

(51) Int. Cl. B32B 3/10; B32B 37/14; B32B 37/00; B32B 37/12; B32B 38/10

(52) U.S. Cl. 428/196; 428/201; 156/308.2; 156/60; 156/256

(57) ABSTRACT

A flexible, impact-resistant laminate includes a first layer of a flexible material and a second, impact-resistant layer. The impact-resistant layer has an impact-resistant material interposed between regions of a closed-cell foam that is bonded to the first layer. The impact-resistance material includes an elastomeric material or, if a third layer of a flexible material is bonded to the closed-cell foam, there is a packing with tightly packed beads or particles. A method of manufacturing such a laminate includes providing a first, flexible layer; bonding regions of a closed-cell foam to an inner side of the first layer; and introducing an impact-resistant material into spaces defined between regions of the closed-cell foam to form a second, impact resistant layer. An inner side of the third layer of a flexible material may be bonded to the closed-cell foam on the other side.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates to a flexible, impact-resistant laminate and a method of manufacturing same.

2. Description of Related Art Including Information Disclosed Under 37 CFR 1.97 and 37 CFR 1.98.

Good impact-resistant materials are those that have good shock absorption, vibration isolation and vibration damping characteristics. Rubber and foam materials are good vibration isolators and absorbers and, for this reason, conventional flexible, impact-resistant materials tend to be manufactured either from closed-cell foam or from gel-setting rubbers. Closed-cell foam is lightweight and can be molded into a variety of shapes. It can, therefore, be readily incorporated into protective wear suitable for the protection of human and animal bodies during, for example, sporting activities and the like. It has the disadvantage, however, that its impact-resistance is limited because, once crushed, it may be damaged and become unable to recover its original degree of springiness. In contrast, gel-setting rubbers have a good impact-resistance and resist damage. However, they are heavy, they do not hold their shape and they are expensive. Whilst they are suitable, therefore, for use in floor-coverings, such as in children's playgrounds, hospitals and on other surfaces where shock absorption and sound-proofing are required, they are difficult to use in protective wear, in upholstery, mattresses and other applications where weight and expense are important considerations.

The object of the present invention is to provide a flexible, impact-resistant laminate that overcomes or substantially mitigates the aforementioned disadvantages.

### BRIEF SUMMARY OF THE INVENTION

According to a first aspect of the present invention there is provided a flexible, impact-resistant laminate comprising a first layer of a flexible material and a second, impact-resistant layer comprising an impact-resistant material interposed between regions of a closed-cell foam that is bonded to the first layer.

Preferably, a third layer of a flexible material is located on the opposite side of the impact-resistant layer to the first layer, the closed-cell foam being bonded to both the first and the third layers.

Preferably also, the impact-resistant material substantially fills the spaces defined between the regions of the closed-cell foam.

Preferably also, at least one of the first and the third layers is resiliently stretchable or elastic and preferably comprises a fabric, although a resiliently stretchable film or sheet could be used. This enables the laminate to adopt a greater range of configurations and helps to prevent puckering of one side of the laminate when it is flexed. Suitable fabrics for use in protective wear and upholstery include knitted nylon and polyester fabrics and more particularly those comprising elastane.

Advantageously, both the first and the third layers of material are resiliently stretchable. However, in cases where only a single stretchable layer is provided and the laminate is to be used in a curved configuration the laminate is preferably arranged so that the stretchable layer lies on the outside surface of the curve.

Suitable fabrics for use in other applications, such as floor-coverings may include woven, heavy-duty fabrics made from natural or man-made materials.

Preferably also, the closed-cell foam is a closed-cell, polyethylene foam but, alternatively, comprises a number of different types of foam, for example layers of foam of different densities.

Preferably also, the impact-resistant material comprises an elastomeric material or a packing comprised of tightly packed beads or particles. Advantageously, the elastomeric material comprises a visco-elastic polymer, a gel-setting rubber or a siloxane. Preferably, however, the elastomeric material comprises a thermoset, polyether-based polyurethane material. In some embodiments, micro-beads such as polystyrene or polyurethane micro-beads may be mixed into the elastomeric material. Alternatively, when the packing is comprised of tightly packed beads or particles, these may comprise any or a combination of, for example, solid polymer spheres, sand, seeds (for example mustard seeds), polystyrene or polyurethane beads. The use of tightly packed beads rather than a solid elastomeric material may reduce the weight of the laminate and also increases its ability to flex. However, it will be appreciated that if beads are used, then the laminate must comprise the third layer in order that the beads are contained between the first and third outer layers of material.

Advantageously, the closed-cell foam is in the form of a cellular matrix the cells of which are filled with the impact-resistant material. Alternatively, the elastomeric material forms a cellular matrix the cells of which are filled with the closed-cell foam material. In this latter case, the foam material is in form of separate blocks of material, which could be of regular or irregular shape, for example hexagonal or octagonal in cross-section.

Preferably, the cells or blocks are evenly distributed between the outer layers with a density of between 100 and 8000 cells or blocks/m². For floor coverings and the like the density can be lower than for protective wear as the greater the density, the greater the flexibility of the laminate. For the former a density between 250 and 8000 cells or blocks/m² is appropriate whereas for protective wear a density between 4000 and 6000 cells or blocks/m² is better as it allows the laminate to flex easily in all directions without “locking up” or preventing movement in a particular direction. Also, it enables the laminate to be cut into small pieces, for example to form protective wear of different sizes, without significantly affecting its ability to flex.

According to a second aspect of the present invention there is provided a method of manufacturing a flexible, impact-resistant laminate comprising the steps of providing a first layer of a flexible material; bonding regions of a closed-cell foam to an inner side of the first layer; and introducing an impact-resistant material into spaces defined between the regions of the closed-cell foam to form a second, impact resistant layer.

Preferably, the method comprises the additional steps of providing a third layer of a flexible material and bonding the closed-cell foam to an inner side of the third layer of material on the other side of the laminate from the first layer of material.

Preferably, the impact-resistant material comprises a thermoset, visco-elastic material which is introduced into the spaces defined between o the regions of the closed-cell foam and allowed to set.

Alternatively, the impact-resistant material comprises a packing comprised of tightly packed beads or particles in the spaces defined between the regions of the closed-cell foam.

Preferably, the closed-cell foam is bonded to the first and third layers by an adhesive; alternatively, it is fused thereto.

Preferably also, the method comprises the additional steps of o providing a sheet of a closed-cell foam material; cutting the sheet into two tessellating patterns; separating the tessellating patterns; bonding a first of said tessellating patterns to the inner side of the first flexible layer; and introducing the impact-resistant material into the void within the first tessellating pattern created by removal of the closed-cell foam material defining the second tessellating such that the impact-resistant material substantially fills said void.

Preferably also, the method comprises the additional step of using the closed-cell foam material defining the second tessellating material once removed from the first tessellating pattern to create a flexible, impact-resistant laminate in accordance with the invention.

Preferably also, at least one of the two opposing faces of the sheet of closed-cell foam material is coated with a hot-melt adhesive prior to the sheet being cut into said tessellating patterns.

Advantageously, the sheet of closed-cell foam is cut into the two tessellating patterns using a cutter grid which is pressed into the foam to cut therethrough. Preferably, the cutter is adapted so that after the sheet of closed-cell foam has been cut the surface of one of the tessellating patterns stands proud of the surface of the other tessellating pattern. Advantageously, therefore, a block arrangement is located within the cutter that causes the tessellating patterns to move relative to one another after the foam has been cut. Alternatively, means, such as ejectors, are provided to achieve this effect. In this way, the closed-cell foam forming the first tessellating pattern can be removed from the cutter grid after it has been bonded to the inner face of the first layer of flexible material leaving the second tessellating pattern in situ in the cutter to be used in the same way with another first layer of flexible material. This means that none of the expensive closed-cell material is wasted.

The tessellating patterns may be identical with one another, for example they may be arranged in a checkerboard pattern or be different. In some cases, it may be appropriate for one of the tessellating patterns to form a cellular matrix. In this case the other tessellating pattern will be the same shape as the cells of the first pattern.

### BRIEF DESCRIPTION OF THE SEVERAL VIEWS OF THE DRAWINGS

Embodiments of the various aspects of the invention will now be described by way of example with reference to the accompanying drawings.

FIGS. 1 and 2 are cross-sectional views of first and second embodiments, being transverse, respectively, of a flexible, impact-resistant laminate according to the first aspect of the present invention.

FIG. 3 is a top plan view of a cellular matrix forming part of an impact-resistant layer incorporated in the first and second embodiments shown in FIGS. 1 and 2.

FIG. 4 is a top plan view of a first embodiment of cutter grid for use in a method according to the second aspect of the present invention.

FIG. 5 is a vertical cross-sectional view, to an enlarged scale, through part of the cutter grid as shown in FIG. 4.

FIGS. 6 to 10 are schematic views of a series of diagrams showing various stages during the manufacture of a laminate as shown in FIG. 1.

### DETAILED DESCRIPTION OF THE INVENTION

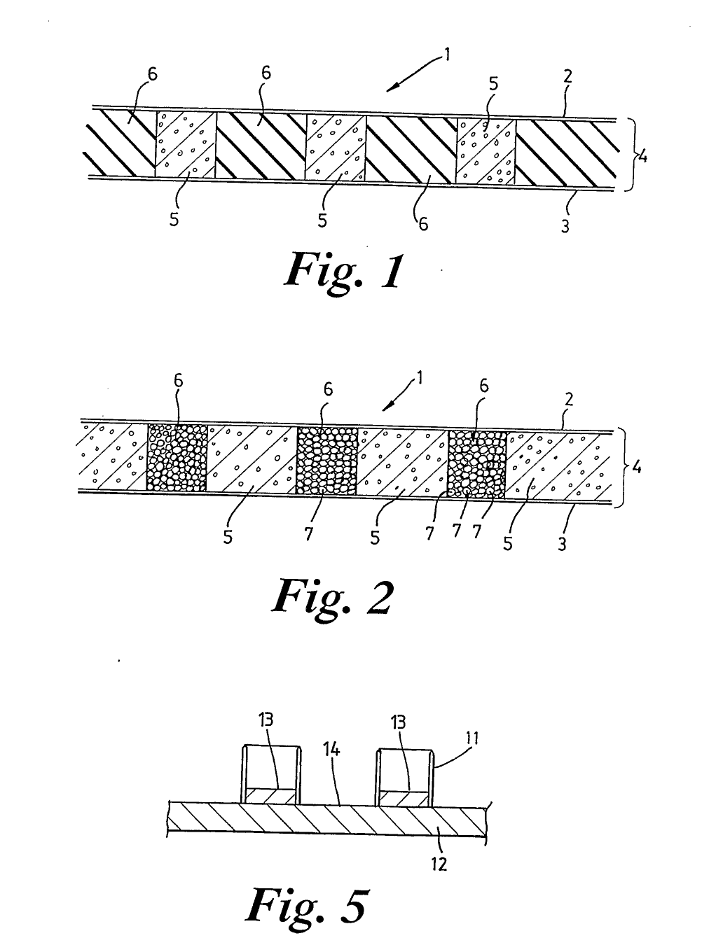

Referring to FIGS. 1 and 2, a flexible, impact-resistant laminate 1 comprises a two outer layers 2, 3 of a flexible material between which is located an impact-resistant impact layer 4. If the laminate is to be used in the production of protective wear or upholstery, the outer layers 2 and 3 are both preferably made of a resiliently stretchable knitted fabric, advantageously one comprising polyester or elastane fibers. However, in a laminate for use as a floor-covering, sound-proofing or in heavy duty situations, then the layers 2 and 3 can be made of a hard-wearing fabric or film that does not need to be stretchable. Suitable films include sheets of polyethylene or polyurethane. Also, in some applications, only one layer 2 is needed, the layer 3 being unnecessary. The impact-resistant layer 4 comprises regions 5 of a closed-cell foam that are bonded to the outer layers 2 and 3 and interspersed with regions of an impact-resistant material 6. The closed-cell foam is preferably a resilient, closed-cell polyethylene foam.

In the first embodiment shown in FIG. 1, the impact-resistant material 6 comprises an elastomeric material, which is preferably a visco-elastic polymer, a gel-setting rubber or a siloxane. Advantageously, however, the elastomeric material comprises a thermoset, polyether-based polyurethane material such as is sold under the name SORBATHANE™ by Sorbathane, Inc. This material is initially in a liquid form prior to curing and then cold-cures into a visco-elastic state which facilitates production of the laminate as described below. Dependent on the use to which the laminate is to be put, micro-beads such as polystyrene beads may be mixed into the elastomeric material. The addition of such beads may reduce the flexibility of the material but improve the dissipation of forces resulting from impacts. This is advantageous, for example, in floor-coverings.

In the second embodiment shown in FIG. 2, the impact-resistant material 6 comprises tightly packed beads or particles 7, example of which have been given above. Beads or particles packed in this way have good shock absorption, vibration isolation and vibration damping characteristics because their packing enables each one to move slightly relative to the others which means that as a whole they act to absorb impact energy.

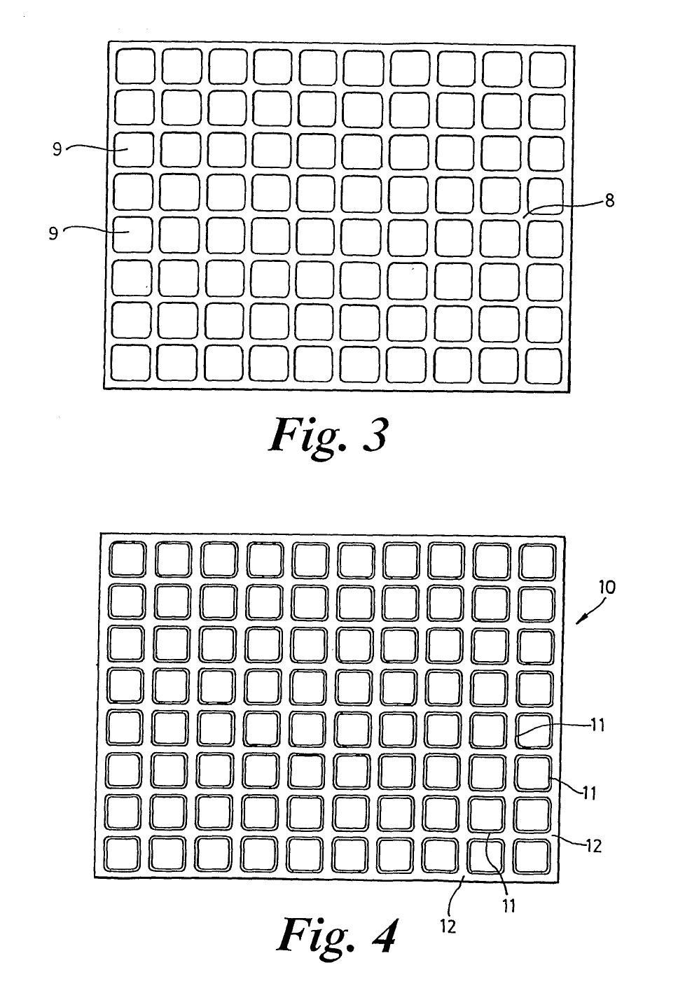

The type of impact-resistant material 6 that is used in the laminate 1 and the use to which the laminate is to be put determines the shape and size of the foam regions 5. Advantageously, the closed-cell foam regions are in the form of a cellular matrix 8, as shown in FIG. 3. The cells 9 of the matrix 8 are filled with the impact-resistant material 6. Such an arrangement can facilitate production, as is described below, because the cells 9 will contain, for example, a liquid impact-resistant material 6 prior to setting and also retain a packing such as the beads or particles 7 whilst the second outer layer 3 (not shown in FIG. 3) is bonded to the matrix 8, as is described below. The cells 8 could be of regular or irregular shape, for example square, hexagonal or octagonal in cross-section.

However, it will be appreciated that the foam regions 5 could be discrete so that the impact-resistant material 6 will effectively form a cellular matrix surrounding cells of foam material.

FIG. 4 shows a plan view of a first embodiment of cutter 10 used for manufacturing the matrix 8 shown in FIG. 3. The cutter 10 comprises a plurality of blades 11 mounted on a back-board 12. The blades 11 define a plurality of squares which define the size of the cells 9. If the laminate 1 is for use in protective wear, for example, the square blades 11 may have sides that are 12 mm long with corners of radius 2.5 mm. Also, the height of the blades 11 of the cutter 10 are arranged to be slightly smaller than the thickness of foam sheet with which the cutter 10 is to be used.

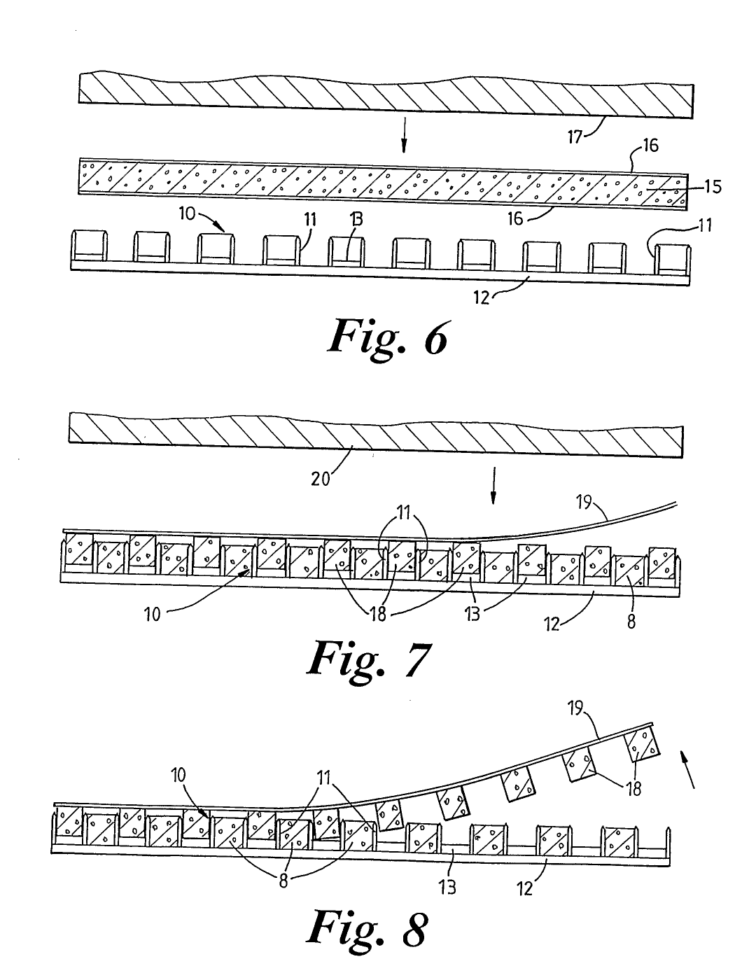

FIG. 5 is a diagram showing a vertical section through one of the blades 11 and the surrounding board 12. It can be seen that within each of the cutter blades 11 is a block 13 which has an upper surface at a level higher than the upper level 14 of the board 12 outside the cutter blades 11. This means that when the cutter 10 is used to cut a sheet of foam 15, the foam is cut into cubes 18 located within the blades 11 and a cellular matrix 8 surrounding the square blades 11 but the foam cubes 18 within the blades are raised above the level of the matrix 8 after cutting. The reason for this will now be explained and the steps involved in manufacturing a laminate using the cutter shown in FIGS. 4 and 5 will now be described with reference to the sequence of drawings as shown in FIGS. 6 to 10.

First, both sides of a 12 mm thick sheet 15 of closed cell foam is coated on both sides with a hot melt adhesive 16. The foam 15 is then placed over a cutter 10, of the type shown in FIGS. 4 and 5, and either pressed down with a press 17, as shown in FIG. 6, or passed through nip rollers (not shown) so that the cutter 10 cuts through the foam 15 to form a cellular matrix 8, as shown in FIG. 3, and a plurality of separate cubes 18. Once the press 17 is removed, owing to its springy nature, the foam 15 will tend to spring back slightly so that its upper surface stands proud above the upper surface of the cutter 10 as defined by the edges of the blades 11. However, as the foam cubes 18 within the blades are supported by the blocks 13 at a higher level than the cellular matrix 8, the cubes 18 stands proud of the surface of the matrix 8 as shown in FIG. 7. The cutter 10 therefore acts as a jig, holding the cut foam in position during the next stage of the manufacturing process.

Next, as shown in FIG. 7, a first layer of material 19 is placed over the foam 15 and the cutter 10. In view of the difference in height between the cellular matrix 8 and the cubes 18, the inner surface of the material 19 only contacts the upper surface of the cubes 18. A heated platen 20 is now brought into contact with outer surface of the material 19 and heat is conducted through the material 19 to the foam of the cubes 18 which activates the adhesive coating 16. This bonds the material 19 to the cubes 18 but not to the cellular matrix 8. Once the adhesive has been activated, the material 19 can be lifted away from the cutter 10 taking the cubes 18 with it and leaving the cellular matrix 8 behind, as shown in FIG. 8. The cellular matrix 8 is then also bonded to another layer of flexible material 19 in exactly the same way as the cubes 8. Hence, none of the foam sheet 15 need be wasted, which is advantageous because it is both expensive to produce and to dispose of as a waste product.

It will be appreciated, therefore, that preferably the cutter 10 is adapted to cut the foam sheet 15 into two tessellating patterns which are both suitable for use in the production of a laminate according to the invention, each pattern having foam regions that are neither too small nor too narrow to be practical. For example, the patterns may comprise one which forms a cellular matrix and the other foam blocks, as in the illustrated embodiment, or both could form blocks in a checkerboard pattern or similar with square or other polygonal shapes. The patterns may also define stripes or swirling patterns. The patterns could also be specially adapted and bespoke for particular applications of the laminate as such a laminate will have different properties in different areas and when flexed in different directions.

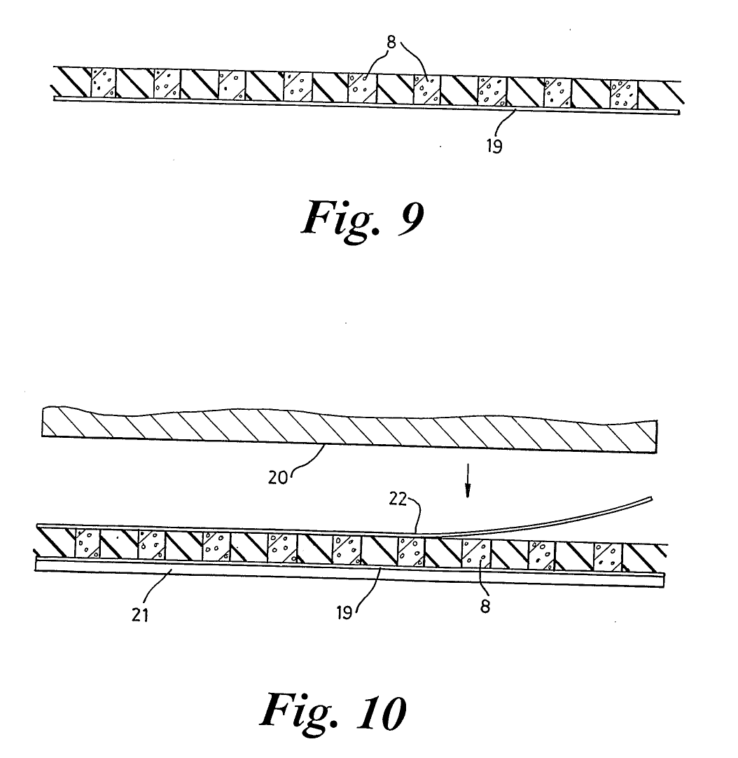

Once the cellular matrix 8 has been bonded to a first layer of material 19, an impact-resistant material 6, as previously described, can be introduced into the cells 9. If an elastomeric material is to be used, the partially made laminate is supported on a board 21 with the cellular matrix 8 uppermost and the elastomeric material is then poured, scraped or sprayed into the cells 9 in a liquid state and then cured or allowed to set, as shown in FIG. 9. Alternatively, if the impact-resistant material 6 comprises a plurality of tightly packed beads or particles, these are packed tightly into the cells 9. Thereafter, the cells 9 are closed by bonding a second layer of flexible material 22 to the other side of cellular matrix using a heated platen 20 in the same way as the first layer of material 19, as shown in FIG. 10.

With foam in the form of the cubes 18, it is still possible to introduce an impact-resistant material 6, as described above, into the spaces between the cubes 18 by supporting the partially made laminate within a tray (not shown). Again, a second layer of a flexible material 22 is then bonded to the other side of cellular matrix using a heated platen in the same way as the first layer of material 19.

Variations to the above method are possible, for example the closed-cell foam may be fused to the layers 19 and 22 by the application of heat so that it partially melts on the surface rather than being adhered thereto. Ejectors could also be used to separate the parts of the foam sheet after it has been cut rather than using the block arrangement 13. In addition, if an elastomeric material is used in the impact-resistance layer between the regions of closed-cell foam, then in some applications the second layer of material 22 can be dispensed with, the laminate comprising simply the first layer of flexible material 19 and the impact resistance layer comprising the elastomeric material interposed between the closed-cell foam regions.

1. A flexible, impact-resistant laminate comprising
a first layer of a flexible material and
a second layer of a flexible material, said material being comprised of an impact-resistant material interposed between regions of a closed-cell foam bonded to said first layer.

2. A laminate as claimed in claim 1, further comprising:
a third layer of a flexible material, being located on an opposite side of said second layer, opposite to said first layer, said closed-cell foam being bonded to both the first and third layers.

3. A laminate as claimed in claim 1, wherein said impact-resistant material substantially fills spaces defined between regions of said closed-cell foam.

4. A laminate as claimed in claim 2, wherein at least one of the first and third layers is resiliently stretchable or elastic.

5. A laminate as claimed in claim 2, wherein the first and/or third layer comprises a fabric or film.

6. A laminate as claimed in claim 1, wherein said closed-cell foam is a closed-cell polyethylene foam.

7. A laminate as claimed in claim 1, wherein said impact-resistant material comprises an elastomeric material.

8. A laminate as claimed in claim 7, wherein said elastomeric material comprises a thermoset, polyether-based polyurethane material.

9. A laminate as claimed in claim 7, wherein said impact-resistant material is further comprised of micro-beads mixed into the elastomeric material.

10. A laminate as claimed in claim 2, wherein said impact-resistant material is comprised of tightly packed beads or particles.

11. A laminate as claimed in claim 10, wherein said tightly packed beads or particles, comprise any or a combination of, solid polymeric spheres, sand, seeds, polystyrene beads and polyurethane beads.

12. A laminate as claimed in claim 1, wherein said closed-cell foam is a cellular matrix, having cells filled with said impact-resistant material.

13. A laminate as claimed in claim 1, wherein said closed-cell foam is comprised of separate blocks of material.

14. A laminate as claimed in claim 12, wherein said cells are evenly distributed between the outer layers with a density of between 100 and 8000 cells/m²

15. A method of manufacturing a flexible, impact-resistant laminate comprising the steps of:
providing a first, flexible layer of material;
bonding regions of a closed-cell foam to an inner side of the first layer; and
introducing an impact-resistant material into spaces defined between regions of said closed-cell foam forming a second, impact resistant layer.

16. A method as claimed in claim 15, further comprising:
providing a third, flexible layer of material; and
bonding said closed-cell foam to an inner side of the third layer of material on the other side of the laminate to the first layer of material.

17. A method as claimed in claim 15, wherein the impact-resistant material comprises a thermoset, visco-elastic material which is introduced into the spaces defined between the regions of the closed-cell foam and allowed to set.

18. A method as claimed in claim 16, wherein the impact-resistant material comprises a impact-resistant material comprises a packing comprised of tightly packed beads or particles in the spaces defined between the regions of the closed-cell foam.

19. A method as claimed in claim 15, wherein said closed-cell foam is bonded to the first and/or third layers or material by an adhesive.

20. A method as claimed in claim 15, further comprising:
providing a sheet of a closed-cell foam material;
cutting the sheet into two tessellating patterns;
separating the tessellating patterns;
bonding a first of said tessellating patterns to the inner side of the first layer of material; and
introducing the impact-resistant material into the void within the first tessellating pattern created by removal of the closed-cell foam material defining the second tessellating such that the impact-resistant material substantially fills said void.

21. A method as claimed in claim 20, further comprising:
using the closed-cell foam material defining the second tessellating material once removed from the first tessellating pattern to create a flexible, impact-resistant laminate in accordance with the invention.

22. A method as claimed in claim 20, wherein opposing faces of the sheet of closed-cell foam material are coated with a hot-melt adhesive prior to the sheet being cut into said tessellating patterns.

23. A method as claimed in claim 20, wherein the sheet of closed-cell foam is cut into the two tessellating patterns using a cutter grid which is pressed into the foam to cut therethrough.

24. A method as claimed in claim 23, wherein the cutter is adapted, the sheet of closed-cell foam being cut, the surface of one of the tessellating patterns standing proud of the surface of the other tessellating pattern.

25. A method as claimed in claim 24, wherein a block arrangement is located within the cutter, the tessellating patterns being moved relative to one another after the sheet of foam has been cut.

26. A method as claimed in claim 23, wherein the cutter is adapted, the sheet of closed-cell foam being cut, both patterns standing proud of the surface of the cutter grid.

27. A method as claimed in claim 20, wherein one of the tessellating patterns defines a cellular matrix.
